(19) United States
(12) Patent Application Publication
(10) Pub. No.: US 2026/0159070 A1
(43) Pub. Date: Jun. 11, 2026

(54) Vehicle with External Parking Control

(71) Applicant: Bendix Commercial Vehicle Systems LLC, Avon, OH (US)

(72) Inventors: Ryan S. Hurley, Lakewood, OH (US); Randy J. Salvatora, Columbia Station, OH (US)

(73) Assignee: Bendix Commercial Vehicle Systems LLC, Avon, OH (US)

(21) Appl. No.: 18/975,023

(22) Filed: Dec. 10, 2024

(51) Int. Cl. B60W 30/06; B60T 7/00; B60W 50/14; B60W 60/00

(52) U.S. Cl. CPC B60W 30/06; B60T 7/00; B60W 50/14; B60W 60/001; B60W 2420/403; B60W 2420/54

(57) ABSTRACT

A vehicle with external parking control is presented, wherein a user input device located external to the vehicle is configured to cause the vehicle to park in response to user input received via the user input device. Having an external user input device for parking control helps ensure safety when a person approaches the vehicle for investigation (e.g., when a driver is found unresponsive inside the vehicle or when an autonomous driving system or a highly-automated driving (HAD) system automatically pulls the vehicle over to the side of the road in response to some fault).

### BACKGROUND

Some commercial vehicles have service brakes that are applied when a driver presses a brake pedal inside the vehicle and parking brakes that are applied/released when the driver pulls/pushes a button on the dashboard inside the vehicle. Some commercial vehicles can be equipped with an autonomous driving system or a highly-automated driving (HAD) system, which can perform actions (e.g., accelerating, braking, and steering) traditionally performed by a human driver.

### BRIEF DESCRIPTION OF THE DRAWINGS

FIG. 1 is an illustration of a vehicle of an embodiment.

FIGS. 2-7 are diagrams of braking systems of embodiments.

FIG. 8 is a flow chart of a method of an embodiment.

### SUMMARY

The following embodiments generally relate to a vehicle with external parking control. In one embodiment, a parking brake system of a vehicle is provided comprising: a first user input device located external to the vehicle, wherein the first user input device is configured to cause the vehicle to park in response to user input received via the first user input device; and a second user input device located internal to the vehicle, wherein the second user input device is configured to cause the vehicle to park and unpark in response to respective user inputs received via the second user input device.

In another embodiment, a method is provided that is performed in a vehicle comprising a user input device located external to the vehicle. The method comprises: receiving user input via the user input device located external to the vehicle; and in response to receiving the user input, causing the vehicle to park.

In yet another embodiment, a vehicle is provided comprising: a user input device located external to the vehicle: and means for causing the vehicle to park in response to user input received via the user input device located external to the vehicle.

Other embodiments are possible, and each of the embodiments can be used alone or together in combination.

### DETAILED DESCRIPTION

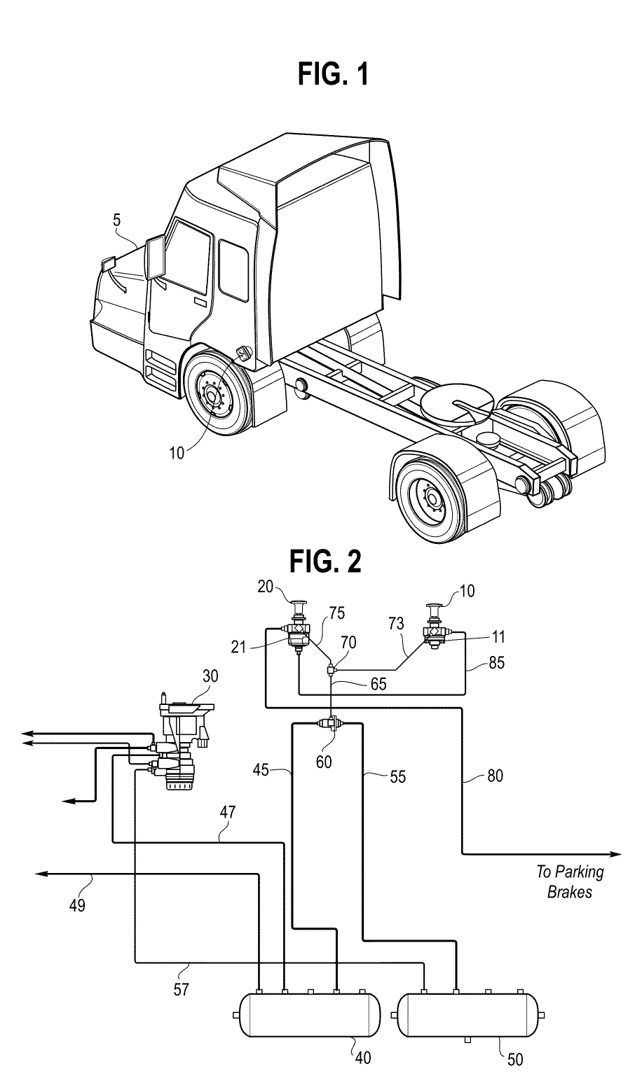

As mentioned above, some commercial vehicles (e.g., a truck, a tractor that can tow a trailer, etc.) have service brakes that are applied when a driver presses a brake pedal inside the vehicle and parking brakes that are applied/released when the driver pulls/pushes a button on the dashboard inside the vehicle. As illustrated in FIG. 1, the vehicle 5 in the following embodiments has a user input device (here, a button 10) outside of the vehicle 5 that is configured to accept a user command to park the vehicle 5. FIG. 1 shows the button 10 located adjacent the driver’s door, but the button 10 can be located in any suitable location on the exterior of the vehicle 5. In one embodiment, the button 10 outside of the vehicle 5 serves as an additional way (e.g. in addition to the button on the dashboard inside the vehicle) to park the vehicle 5. In other embodiments, the button 10 outside of the vehicle 5 can be used to both park and unpark the vehicle 5.

It should be noted that while the user input device takes the form of a button 10 in this example, the user input device can take any suitable form, such as, but not limited to, a switch, a wheel, a slider, a dial, a knob, a touch-sensitive screen/pad, a microphone for audio input (e.g., to capture a voice command or sound), a camera for video input (e.g., to capture a hand or facial gesture), etc.). As illustrated by these examples, the user input device need not be a mechanical, movable input device, although such a device may be preferred for robustness and reliability. Also, in some examples, more than one user input device can be used to provide a parking command, such as when a user is required to hold a safety switch to cause the button 10 to be movable.

Having an external user input device for parking control can have many advantages. For example, if a driver is found unresponsive inside the vehicle 5, a person (e.g., a police officer) approaching the vehicle 5 to investigate the situation can push (or, in other examples, pull) the button 10 to park the vehicle 5 so that vehicle 10 does not roll away, thereby ensuring the person’s safety. A similar situation can occur when the vehicle 5 is equipped with an autonomous driving system or a highly-automated driving (HAD) system (e.g., a “virtual driver”) that automatically pulls the vehicle 5 over to the side of the road in response to some fault. A person (e.g., a service technician) approaching the vehicle 5 to investigate the situation can push the button 10 to park the vehicle 5 and give the person confidence that the vehicle 5 is truly stationary and that the vehicle 5 will not make an unexpected movement that can endanger the person. Also, use of an external parking control avoids the need for the person to enter the vehicle 5 to pull the dashboard parking button when the vehicle 5 is potentially unstable (e.g., because of gravity moving the vehicle 5 and/or because the autonomous driving system may engage the engine to propel the vehicle 5).

The following paragraphs describe several example implementations of these embodiments, which include structures that correspond to means for causing a vehicle to park in response to user input received via a user input device located external to the vehicle. It should be understood that these are merely examples and that other implementations can be used. As such, the details presented herein should not be read into the claims unless expressly recited therein.

Turning again to the drawings, FIG. 2 is an illustration of a brake control system of an embodiment. As shown in FIG. 2, this system comprises a button 10 located externally on the vehicle 5 (here, the vehicle 5 is a “straight truck” that does not tow a trailer) and a button 20 located internally in the vehicle 10 (e.g., on or near the dashboard in the cab of the vehicle 5). Each button 10, 20 can be part of a respective parking control unit 11, 21 that includes a valve or other mechanism configured, at least in part, to cause the vehicle’s parking brakes to be applied in response to user input provided via the button.

The internal parking control unit 21 associated with the internal button 20 can have the same or different configuration as the external parking control unit 11 associated with the external button 10. In this example, the parking control units 11, 21 associated with each button 10, 20 are different. More specifically, in this embodiment, the internal parking control unit 21 comprises a pneumatic pull/push parking valve that selectively opens/closes by pulling/pushing the internal button 20. In contrast the external parking control unit 11 comprises a momentary push valve that does not maintain its state without the external button 10 being held in the pressed position. (It should be noted that while the button 10 is located external to the vehicle 5, the valve and/or other portions of the external parking control unit 11 can be located internal to the vehicle 5.) In this example implementation, both buttons 10, 20 can be used to park the vehicle 5, but only the internal button 20 can be used to unpark the vehicle 5. In other implementations, both buttons 10, 20 can be used to both park and unpark the vehicle 5.

As shown in FIG. 2, primary and secondary air tanks 40, 50 supply compressed air to a foot brake module 30 (via hoses/lines 47, 57), which is used to apply the service brakes of the vehicle 5 when a driver presses a brake pedal. The primary and secondary air tanks 40, 50 further supply compressed air to the transmission and accessories of the vehicle 5 (via hose 49). To simply this discussion, the details of the service brake system, transmission, and accessories will not be described herein. The primary and secondary air tanks 40, 50 also supply compressed air (via hoses 45, 55) to a select-high, double check valve 60 that provides air of greater pressure to another check valve 70, which provides compressed air to the valves in the external and internal parking control units 11, 21 (via hoses 73 and 75, respectively).

Turning first to the operation of the internal button 20, to unpark the vehicle 5, the driver would push the internal button 20, which causes the parking brake valve in the internal parking control unit 21 to open, allowing the pressurized air supplied by hose 75 to flow (via hose 80) to the vehicle’s parking brakes. In this example, the vehicle’s parking brakes comprise parking brake springs that are mechanically biased to apply pressure on braking components at the wheel ends to park the vehicle 5. When the user pushes the internal button 20, the pressurized air supplied to the spring brake chambers “inflates” the parking brake springs from their default braking position, thereby releasing the pressure on the braking components at the wheel ends to unpark the vehicle.

To park the vehicle 5, the driver would pull the internal button 20 to close the parking brake valve in the internal parking control unit 21, which prevents pressurized air to flow from hose 75 to hose 80 and also causes whatever pressurized air is in hose 80 and the spring brake chambers to vent to the atmosphere. In the absence of pressurized air, the parking brake springs’ mechanical bias causes the parking brake springs to re-apply pressure on braking components at the wheel ends, thereby parking the vehicle 5.

Turning now to the operation of the external button 10, to park the vehicle 5, a person would push the external button 10 to cause a valve inside the external parking control unit 11 to open. Opening the valve allows pressurized air to flow (via hose 73 and hose 85) to a pilot port on the internal parking control unit 21, which causes the internal button 20 to “pop out.” “Popping-out” the internal button 20 has the same effect as a driver pulling the internal button 20 to park the vehicle 5, as described above. In this example, pressing the external button 10 when the vehicle 5 is already parked has no effect on the state of the vehicle 5. Also, as mentioned above, in this example, the external button 10 only has the ability to park (and not unpark) the vehicle 5. However, in other implementations, the braking system can be modified to allow the external button to both park and unpark the vehicle 5.

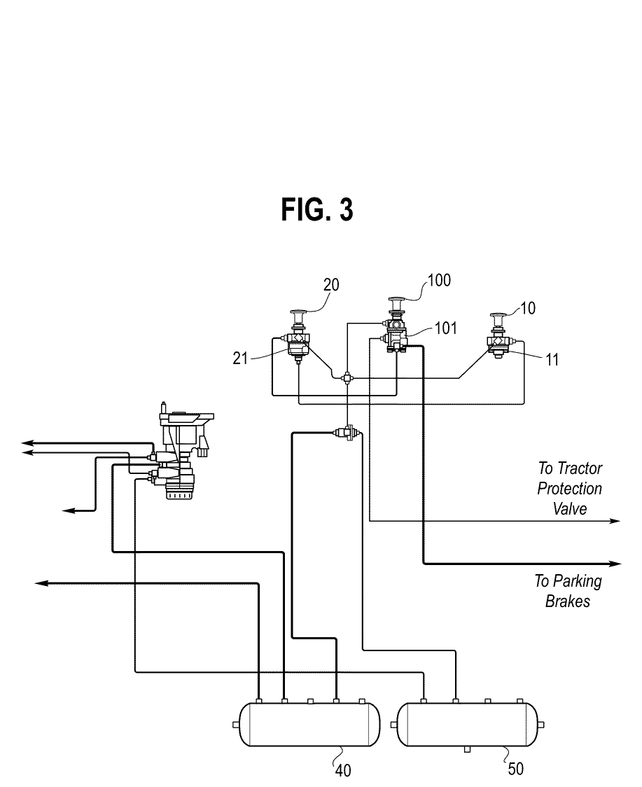

FIGS. 3-6 show other example braking systems. Discussion of components that are the same or similar to those already discussed are not repeated to simplify the discussion. Again, these are merely examples, and other implementations can be used.

Turning first to FIG. 3, FIG. 3 is a diagram of a braking system of another embodiment. As shown in FIG. 3, the braking system of this embodiments comprises a trailer parking brake button 100 and an associated trailer parking control unit 101, which comprises a push-pull pneumatic valve that controls the air supply to the parking brakes of a trailer (the “towed vehicle”) towed by the vehicle cab (the “power unit”). The parking brake of the trailer can be controlled independently from the parking brake of the cab, but, in this example, parking the power unit also parks the trailer if it is unparked (e.g., if its parking spring brakes are released). That is, pulling the internal button 20 causes the parking brake valve in the internal parking control unit 21 to close, which prevents pressurized air to flow into the trailer parking control unit 101. Such pressurized air is required by the trailer parking control unit 101 to allow pressurized air to be provided to the tractor protection value to release the trailer’s spring brakes. Thus, pulling the internal button 20 prevents the trailer from being unparked.

As in the above example, pushing the external button 10 causes a valve inside the external parking control unit 11 to open. This causes pressurized air to flow to the pilot port on the internal parking control unit 21, which causes the internal button 20 to “pop out.” As also in the above example, this results in preventing pressurized air to be applied from the internal parking control unit 21 to the parking brakes. However, in this embodiment, this action also results in preventing pressurized air to flow into the trailer parking control unit 101, which causes the parking brakes of the trailer to be applied.

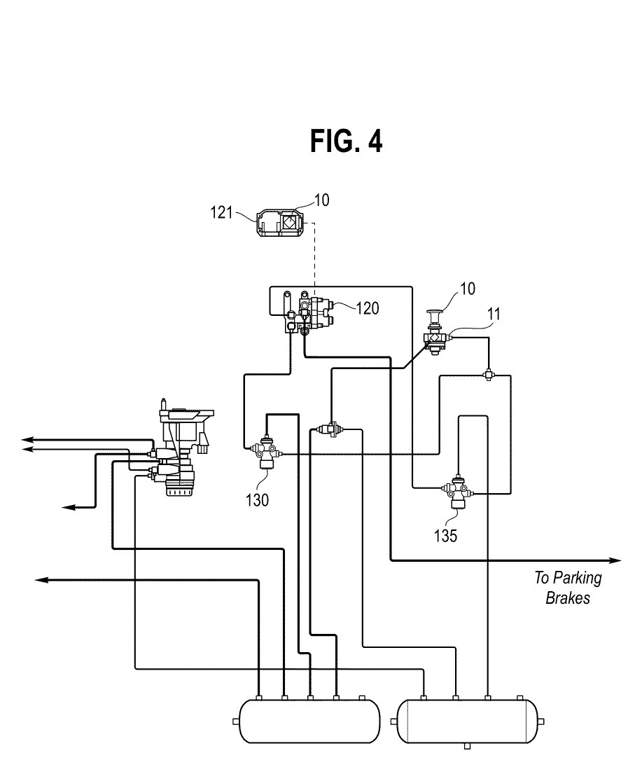

FIG. 4 illustrates a braking system that is similar to the one in FIG. 2; however, instead of the internal button 20 being part of a mechanical internal parking control unit 21, the internal button 20 is part of an electronic internal parking control unit 121. The electronic internal parking control 121 can take any suitable form and can comprise, for example, one or more processors that can execute computer-readable program code having instructions (e.g., modules, routines, sub-routine, programs, applications, etc.) that, when executed by the one or more processors, cause the one or more processors to perform certain functions, such as, but not limited to, the functions discussed herein. The computer-readable program code can be stored in a non-transitory computer-readable storage medium, such as, but not limited to, volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof, some or all of which can be located internal to or external to the controller. The one or more processors can also take the form of a purely-hardware implementation (e.g., an application-specific integrated circuit (ASIC)).

In this embodiment, instead of opening/closing an internal valve, movement of the internal button 20 causes an electronic signal to be sent (via a wired or wireless connection, as denoted by the dashed line) to a pneumatic valve module 120, which comprises a solenoid valve that is electrically-controlled by the electronic signal sent by the electronic internal parking control unit 121. Instead of or in addition to the electronic signal being generated by a driver pushing/pulling the internal button 20, the electronic signal can be generated in response to a command signal from an autonomous driving system to park the vehicle.

In operation, when the electronically-controlled pneumatic valve module 120 receives the electronic signal from the electronic internal parking control unit 121 to park the vehicle 5 (as requested by a human or virtual driver), the solenoid valve in the pneumatic valve module 120 closes, which prevents pressurized air from reaching the parking brakes and vents whatever pressurized air has been previously supplied (thereby parking the vehicle). When the external parking button 10 is pressed, the external parking control unit 11 pressurizes the control port of inversion valves 130, 135, venting the delivery air to atmosphere, which causes the pneumatic valve module 120 to automatically apply the parking brakes due to a lack of supply pressure.

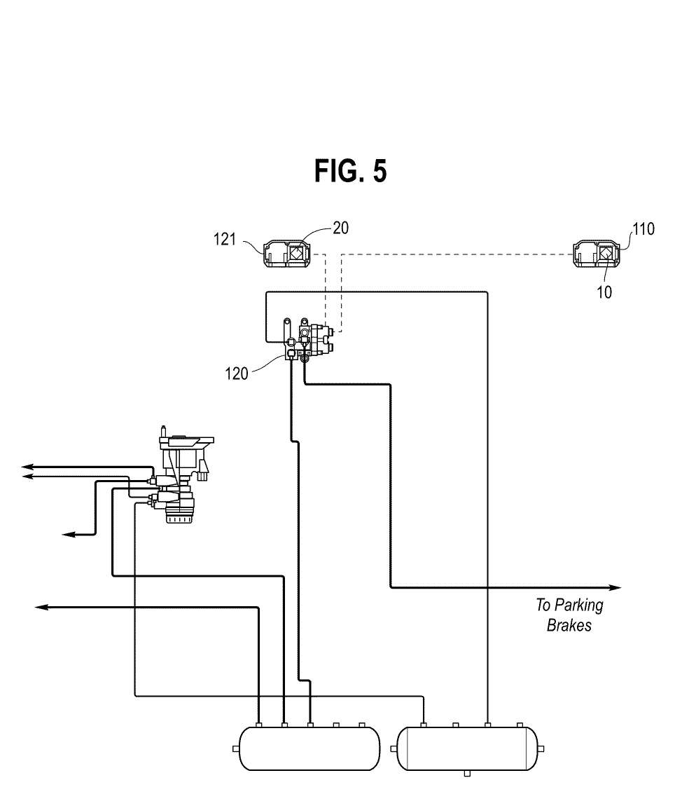

FIG. 5 is a variation of this embodiment, where instead of the external button 10 being part of a mechanical external parking control unit 11, the external button 10 is part of an electronic external parking control unit 111, which take the same or similar form to the electronic internal parking control unit 121. This mechatronic component 111, when pressurized by someone pressing the external button 10, can send an electronic signal to the pneumatic valve module 120 to apply the parking brakes, as discussed above. Depending on configuration and software development, this button 140 can perform many/all of the functions as the internal button 20 on the electronic internal control unit 121 inside the cab of the vehicle, or it can be limited to just park (and not unpark). For robustness, a redundant/back-up power supply (e.g., a battery back-up) may be used with the external electronic control unit 111 to help ensure it is operational in the event of power loss in the vehicle.

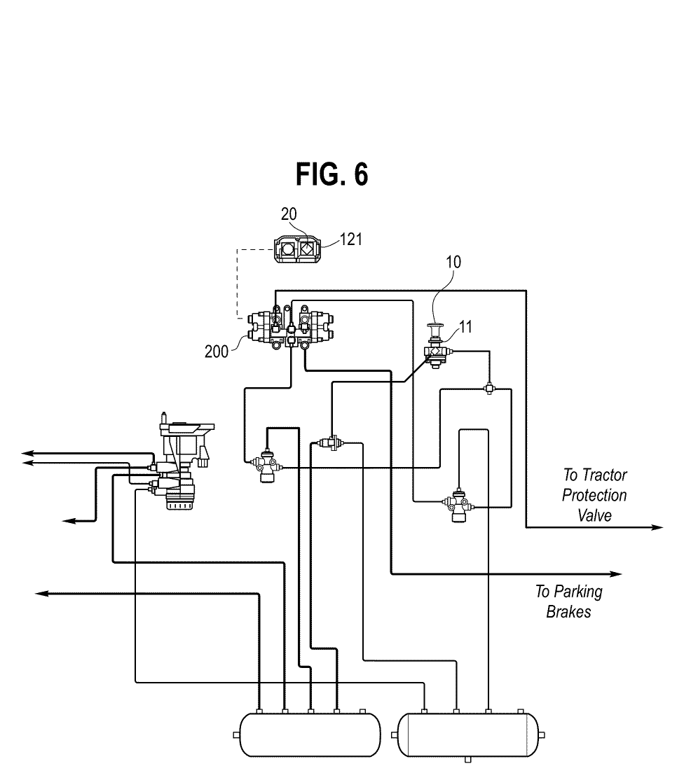

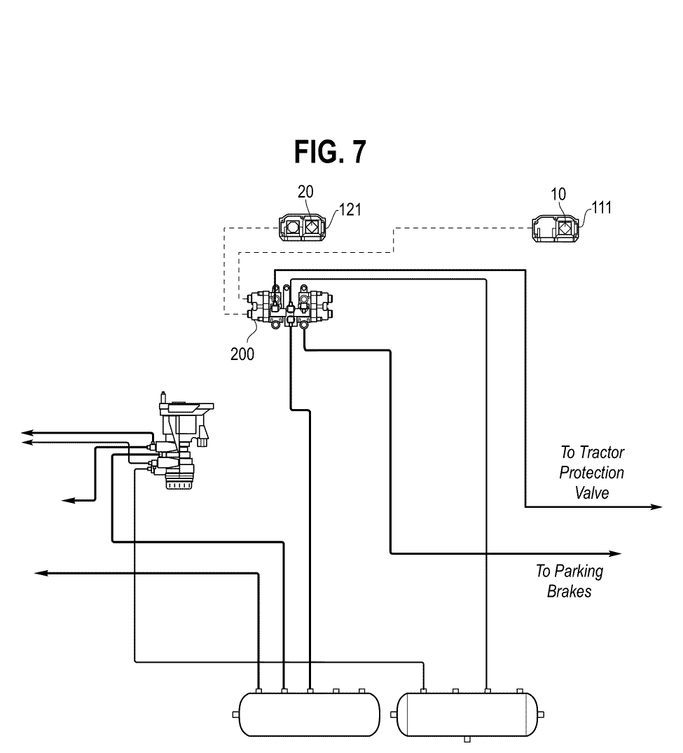

In the alternative shown in FIG. 6, a pneumatic valve module 200 controls parking of both the tractor and the trailer. In operation, when the external parking button 10 is pressed, it will pressurize the control port of inversion valves 130, 135, venting the delivery air to atmosphere, which causes the pneumatic valve module 200 to automatically apply the parking brakes to both the tractor and the trailer due to a lack of supply pressure. The system shown FIG. 7 is similar but uses both an electronic external parking control unit 111 and an electronic internal parking control unit 121.

These embodiments can be used in any suitable environment. In the following example use case, these embodiments are used in a vehicle that has an autonomous driving system. As mentioned above, it is possible that an autonomously-controlled vehicle may need to be parked from outside the cab of the vehicle (e.g., if there is a safety concern, if the vehicle is not responding properly, or as a safety measure to prevent against unintended movement). Autonomous vehicles are intended to have redundant electrical control over the parking brakes, but, in the event of a failure, a separate, externally-accessible user-activated park switch can be advantageous. Currently, electronic parking brakes for autonomous vehicles are in a state of maturity where they offer a limited amount of redundancy. Eventually, the entire brake control system may be in a state of maturity where there will be additional redundant controls preventing the application of parking, but, until that functionality is brought on-line, there will be a gap in system maturity, especially with respect to fault handling. These embodiments can be used to address that situation.

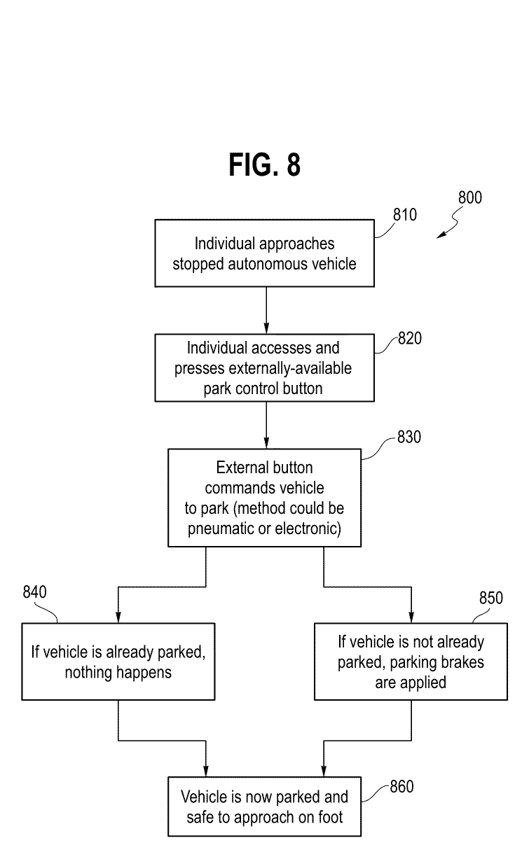

As mentioned above, if a vehicle faults and needs to pull over, it is possible that the vehicle will not be able to maintain control over the primary park brake control. With these embodiments, a human third party (e.g., safety driver, a law enforcement officer, a tow truck driver, etc.) can use the external button to mechanically park the vehicle without accessing the cab of the vehicle. FIG. 8 is a flow chart 800 of a method that illustrates this example. As shown in FIG. 8, in this method, an individual approaches the stopped autonomous vehicle (810) and accesses and presses the externally-available park control button (820). This pneumatically or electronically (depending on the implementation) commands the vehicle to park (830). If the vehicle is already parked, pressing the button causes no action (840). However, if the vehicle is not already parked, pressing the button parks the vehicle (850). Either way, the vehicle can be safely approached (860). Again, this is merely an example, and other methods and use cases can be used.

As illustrated by the examples provided herein, these embodiments can use any suitable components. Such component can include, but are not limited to, (1) a physical control interface with the parking system, either pneumatic or electronic (depending on the parking control system on the vehicle), (2) feedback to the operator on the status of the parking system, which could be the physical position of the button, lights, indicators, or other visible feedback, and (3) a way to display the parking status of the vehicle that is visible not only at the control interface described herein but also from a significant distance away to quickly show at-a-glance the status of the vehicle (e.g., a large light, a display screen, etc.).

Depending on the desire of the end user, different control options can be used. Such options can include, but are not limited to, (1) full park/unpark capability (e.g., using a separate mechanical device), (2) park-only capability (e.g., the vehicle can only be parked with no ability to release the parking brakes), and (3) park with momentary unpark (e.g., the vehicle can be parked and parking brakes can be released only while holding the control).

It should be understood that the embodiments provided in this Detailed Description are merely examples and that other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A parking brake system of a vehicle, the parking brake system comprising:
a first user input device located external to the vehicle, wherein the first user input device is configured to cause the vehicle to park in response to user input received via the first user input device; and
a second user input device located internal to the vehicle, wherein the second user input device is configured to cause the vehicle to park and unpark in response to respective user inputs received via the second user input device.

2. The parking brake system of claim 1, wherein the first user input device is further configured to cause the vehicle to unpark in response to another user input received via the first user input device.

3. The parking brake system of claim 1, wherein:
the first user input device is coupled with a valve configured to open in response to the user input received via the first user input device; and
opening the valve allows a flow of pressurized air that causes a movement of the second user input device that causes the vehicle to park.

4. The parking brake system of claim 3, wherein:
the parking brake system further comprises a third user input device located internal to the vehicle, the third user input device being configured to cause a trailer to park and unpark in response to respective user inputs received via the third user input device; and
opening the valve allows a flow of pressurized air that causes a movement of the third user input device that causes the trailer to park.

5. The parking brake system of claim 3, wherein:
the second user input device is configured to cause the vehicle to park by sending an electronic signal to an electrically-controlled solenoid valve in a pneumatic valve module; and
opening the valve allows a flow of pressurized air to the pneumatic valve module, which causes the vehicle to park.

6. The parking brake system of claim 5, wherein:
allowing the flow of pressurized air to the pneumatic valve module further causes the electronic control unit to park a trailer.

7. The parking brake system of claim 1, wherein:
the first user input device is part of an electronic control unit; and
the first user input device is configured to cause the vehicle to park by causing the electronic control unit to send an electrical signal to an electrically-controlled solenoid valve to close in response to the user input received via the first user input device.

8. The parking brake system of claim 7, wherein:
the first user input device is further configured to cause a trailer to park by causing the electronic control unit to send the electrical signal.

9. The parking brake system of claim 1, wherein the first user input device comprises a push button and the second user input device comprises a push-pull button.

10. The parking brake system of claim 1, wherein the first user input device comprises a button, a switch, a wheel, a slider, a dial, a knob, a touch-sensitive screen/pad, a microphone for audio input, or a camera for video input.

11. The parking brake system of claim 1, wherein the vehicle comprises an autonomous driving system or a highly-automated driving (HAD) system.

12. A method comprising:
performing in a vehicle comprising a user input device located external to the vehicle:
receiving user input via the user input device located external to the vehicle; and
in response to receiving the user input, causing the vehicle to park.

13. The method of claim 12, wherein the user input is received after an autonomous driving system or a highly-automated driving (HAD) system of the vehicle causes the vehicle to pull over.

14. The method of claim 12, further comprising:
providing an indication visible external to the vehicle that the vehicle is parked.

15. The method of claim 12, wherein the user input device located external to the vehicle is part of a parking control unit configured with park-only capability.

16. The method of claim 12, wherein the user input device located external to the vehicle is part of a parking control unit configured with park/unpark capability.

17. The method of claim 12, wherein the user input device located external to the vehicle is part of a parking control unit configured with park-with-momentary-unpark capability.

18. The method of claim 12, wherein the user input device comprises a pneumatic interface with a parking brake system of the vehicle.

19. The method of claim 12, wherein the user input device comprises an electronic interface with a parking brake system of the vehicle.

20. A vehicle comprising:
a user input device located external to the vehicle: and
means for causing the vehicle to park in response to user input received via the user input device located external to the vehicle.
